(19) United States
(12) Patent Application Publication
(10) Pub. No.: US 2014/0260401 A1
(43) Pub. Date: Sep. 18, 2014

(54) HOT PRODUCT IMPINGEMENT FREEZER WITH IMPINGEMENT BELT APPARATUS

(71) Applicants: Simon James SHAMOUN, Acworth, GA (US); Stephen A. McCORMICK, Warrington, PA (US)

(72) Inventors: Simon James SHAMOUN, Acworth, GA (US); Stephen A. McCORMICK, Warrington, PA (US)

(21) Appl. No.: 13/803,469

(22) Filed: Mar. 14, 2013

(51) Int. Cl. A23L 3/36

(52) U.S. Cl. CPC A23L 3/36
USPC 62/303; 62/340

(57) ABSTRACT

An impingement apparatus for use with a freezer includes a flexible belt having a first surface, a second surface opposite to the first surface, and a plurality of impingement holes extending through the belt between the first and second surfaces, wherein a passageway is formed in each one of the plurality of impingement holes and through which a cooling medium can pass.

### BACKGROUND

The present embodiments relate to apparatus and methods to chill or freeze products, such as for example warm food products or food products emitting steam vapor.

Heated products having “steamy” characteristics due to their moisture content are a challenge to freeze. This is due to the moisture content in the water evaporating off the product to cause same to “plate out” or stick to cold, inner surfaces of the freezing apparatus or system for the product. Generally, moisture vapor from the product will freeze on surfaces inside the freezer. In a cryogenic tunnel freezer for example, the moisture will collect on fan blades used to circulate the cryogenic gas and thereafter compromise the blades effectiveness and eventually render the blades useless. In mechanical freezers, the moisture that is frozen usually ends up on the evaporator coils inside the freezer, resulting in blockage and ineffective use of the coils.

Cryogenic immersion freezers have been used to overcome the deficiencies of cryogenic tunnel and mechanical freezers with respect to “steamy” products, such as food products. This is because cryogenic immersion freezers do not require moving parts for circulation of the freezing gas flow or evaporator coils. In a cryogenic immersion freezer, the food product is immersed in a bath of liquid nitrogen for freezing. However, cryogenic immersion freezers are extremely inefficient and not cost-effective when operating as stand-alone freezers for steamy food products.

In addition, holes in an impingement plate used in a cryogenic tunnel freezer can clog or be sealed from the snow created by the steamy product condensation vapor. Accordingly, such freezers will need vibrators to mechanically clear the impingement holes of the frozen condensate.

A freezer is therefore needed for steamy products, such as food products, which does not have the disadvantages of known cryogenic tunnel and mechanical freezers, or cryogenic immersion freezers.

### BRIEF DESCRIPTION OF THE DRAWINGS

For a more complete understanding of the present embodiments, reference may be had to the following description taken in conjunction with the drawing Figures, of which:

FIG. 1 shows a side view in cross-section of an inpingement freezer embodiment for freezing hot products; and

FIG. 2 shows a view taken along line 2-2 in FIG. 1.

Before explaining the present embodiments in detail, it is to be understood that the invention is not limited in its application to the details of construction and arrangement of parts illustrated in the accompanying drawings, since the invention is capable of other embodiments and of being practiced or carried out in various ways. Also, it is to be understood that the phraseology or terminology employed herein is for the purpose of description and not of limitation.

### DETAILED DESCRIPTION OF THE INVENTION

The embodiments of FIGS. 1 and 2 use a flexible moving conveyor belt having for example a metallic frame and a plastic (ultra high molecular weight (UHMW) or similar material) support members with a plurality of holes therethrough to maximize heat transfer coefficient of the freezing process and to accordingly be continuously cleared of any frozen concentrate. The plastic conveyor belt of the present embodiments is operable in atmospheres having cryogenic temperatures and is of a hygienic structure.

Referring to FIGS. 1 and 2, the embodiments include an impingement belt apparatus shown generally at 10 and operatively associated with a freezer 12. The freezer 12 is used to substantially reduce the temperature, such as to chill or freeze, products such as food products 14 which are introduced into the freezer in a warm or perhaps steam emitting phase from just being cooked or otherwise heated. The apparatus 10 can be retrofitted to existing freezers.

The freezer 12 includes a housing 16 consisting of opposed side walls 18,20, a top 22 or roof, a bottom 24, a front wall 26 and a back wall 28. A chamber 30 or internal space is disposed within the housing 16, and it is within the chamber that the chilling or freezing of the food products 14 occurs.

The front wall 26 is provided with an inlet 32 to the chamber 30, while the back wall 28 is provided with an outlet 34 from the chamber. The inlet 32 and the outlet 34 are sized and shaped to permit a conveyor belt 36 having an upper run 38 and a lower run 40 to pass through the chamber 30 via the inlet and the outlet 34, as shown in particular in FIG. 1.

Referring to FIG. 1, two pairs of blowers are shown for example disposed for operation in the chamber 30. That is, an upper pair of blowers 42, 44 or fans are mounted to the top 22 of the housing 16. Each of the blowers 42,44 includes a motor 46,48, respectively, which is attached via a shaft 50,52 to a blower wheel 54,56 of the corresponding blower. While the motors 46,48 are mounted external to the housing 16, the shafts 50,52 and blower wheels 54,56 are disposed in the chamber 30. Each one of the upper blowers 42,44 is provided with a corresponding louvered housing 58,60, respectively. The louvered housings 58,60 are disposed in the chamber 30 mounted to an inner surface of the top 22 of the housing 16. The remaining side walls of the louvered housings 58,60 can be selectively opened or closed, as shown in FIGS. 1 and 2, to control and vary a flow rate of the chilling atmosphere in the chamber 30. For example, as shown in FIGS. 1 and 2, louvers 62,64 of the corresponding louvered housings 58,60 are all in an open position for maximum circulatory air flow within the chamber 30.

Referring still to FIG. 1, a lower pair of blowers 66,68 or fans are shown disposed for operation in the chamber 30. That is, the lower pair of blowers 66, 68 are mounted to the bottom 24 of the housing 16. Each of the blowers 66,68 includes a motor 70,72, respectively, which is attached via a shaft 74,76 to a blower wheel 78,80 of the corresponding blower. While the motors 70,72 are mounted external to the housing 16, the shafts 74,76 and the blower wheels 78,80 are disposed in the chamber 30. Due to the perspective of FIGS. 1 and 2, the motor 70 is obscured from view and is therefore presented with a broken line in FIG. 1. Each of the lower blowers 66,68 is provided with a corresponding louvered housing 82,84, respectively. The louvered housings 82,84 are disposed in the chamber 30 mounted to an inner surface of the bottom 24 of the housing 16. The remaining side walls of the louvered housings 82,84 can be selectively opened or closed, as shown in FIGS. 1 and 2, to control and vary a flow rate of the chilling atmosphere in the chamber 30. For example, as shown in FIGS. 1 and 2, louvers 86,88 of the corresponding louvered housings 82,84 are all in an open position for maximum circulatory air flow within the chamber 30.

As shown in FIGS. 1 and 2, one or a plurality of the impingement belt apparatus 10 may be used with the freezer. Referring in particular to FIG. 1, the impingement belt apparatus 10 includes a continuous flexible belt 100 having a plurality of holes 102 or apertures formed therein. The holes 102 permit air flow circulated through the chamber 30 to pass through the belt 100 as shown by the arrows 104. The belt 100 is mounted for movement about a plurality of rollers 106 or pulleys.

The apparatus 10 also includes a belt cleaner 108 mounted in the chamber 30 to be operationally associated with the belt 100. The belt cleaner includes a plurality of projections 110, such as posts or fingers, sized and shaped so that they can be received in the holes 102. The belt cleaner 108 can be constructed as a drum 112 rotatable about its central axis at an axial 114. The drum 112 is rotatable by any number of known motors or mechanical applications such that the rotation of the drum 112 brings the projections 110 into registration with the holes 102 to force out or extrude any frozen condensate in the holes from the belt.

As shown in FIG. 1, the drum 112 of the apparatus 10 is disposed at a downstream end or near the outlet 34 of the housing 16. This position may be more beneficial during freezing operations because introduction of the food product 14, which is in a heated or steam emitting phase, into the chamber 30 through the inlet 32 will provide the greatest amount of steam vapor resulting in condensate when subjected to the cryogen atmosphere being circulated within the chamber. Therefore, as the conveyor belt 36 is moved through the chamber 30 and as the impingement belt 100 is also moved through the chamber, condensate will begin to rapidly form in the holes 102 of the belt 100 such that there is an increased chance that a greater number of the holes 102 will be substantially clogged or caked with frozen condensate by the time the belt 100 approaches the outlet 34. Therefore, it is at this position as shown in FIG. 1 that the projections 110 of the drum 112 will be most effective because they will remove the greatest amount of condensate in the holes 102 prior to the belt 100 returning along its continuous path back to a position proximate the inlet 32.

As also shown in FIGS. 1 and 2, another impingement belt apparatus shown generally at 210 can be mounted for operation at a lower portion of the chamber 30 within the housing 16. Elements illustrated in FIGS. 1 and 2 corresponding to the impingement belt apparatus 10 have been designated by corresponding reference numerals increase by 200, and such elements are designed for use in the same manner as the elements of the apparatus 10.

As shown in FIG. 2, the upper blowers 42,44 and the lower blowers 66,68 are offset in the chamber 30 from the impingement belt apparatus 10,210. The louvers 62,64 and 86,88 for each of the respective housings 58,60 and 82,84 can be selectively positioned in any combination of open and closed positions in order to adjust the air flow and circulatory effect of the chilling atmosphere within the chamber 30. A cryogen gas, such as nitrogen, can be introduced into the chamber 30 with any known and acceptable apparatus or systems (not shown).

The holes 102, 202 may be of different diameters and arranged in different patterns in the impingement belt 100,200 depending upon the food product to be chilled or frozen and the amount of time necessary to provide the heat transfer coefficient. An increased heat transfer rate is provided by the impingement belt apparatus 10,210.

The upper blowers 42,44 and the lower blowers 66,68 can also cycle from an operating (chilling/freezing) mode to a defrost mode. That is, when necessary, one of the upper blowers 42,44 and/or the lower blowers 66,68 will cycle off and have the respective louvers 62, for example, closed so that same can be defrosted. The other one of the blowers will remain in operation and continue circulating the atmosphere within the chamber 30. The defrost cycle for the corresponding blower to be defrosted can occur with a warm gas, which can be exhaust gas if necessary to maximize efficiency of the freezer 12. The defrost cycle can continue concurrent with and throughout the operating cycle of the remaining blowers. Accordingly, that is why the blowers 66,68 are disposed at the bottom 24 of the housing 16 which will facilitate drainage if defrosting is to occur.

With respect to the embodiments shown at FIGS. 1 and 2 and the louvered housings 58,60 and 82,84, for such housings, at least two sides of each one of the respective housings must be louvered, preferably opposed sides of the housing, to provide the necessary intake and exhaust for the circulatory flow of the chilling atmosphere in the chamber 30. The remaining sides which do not have louvers, such as for example 62,64, can be of solid construction.

The impingement belt 100,200 can be arranged around the respective roller 106,206 as a continuous loop or belt, and can be manufactured from stainless steel, low temperature resistant plastic or low temperature resistant polymer. The projection member 109,209 can extend for example from 4 mm to 30 mm from a surface of the drum 112,212, and similarly for example be manufactured from stainless steel, low temperature resistant plastic or low temperature resistant polymer

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An impingement apparatus for use with a freezer, comprising:
a flexible belt having a first surface, a second surface opposite to the first surface, and a plurality of impingement holes extending through the belt between the first and second surfaces, wherein a passageway is formed in each one of the plurality of impingement holes and through which a cooling medium can pass.

2. The impingement apparatus of claim 1, wherein the flexible belt is disposed as a continuous loop within the freezer.

3. The impingement apparatus of claim 1, further comprising:
a cleaning apparatus disposed proximate the flexible belt and having a plurality of projection members extending from the cleaning apparatus, each one of the plurality of projection members sized and shaped to contact a corresponding one of the plurality of impingement holes to dislodge material and frozen condensate in the passageway of the impingement hole.

4. The impingement apparatus of claim 3, wherein the cleaning apparatus is disposed within the freezer.

5. The impingement apparatus of claim 3, wherein the cleaning apparatus is in registration with the first surface of the flexible belt.

6. The impingement apparatus of claim 3, wherein the cleaning apparatus is in registration with the second surface of the flexible belt.

7. The impingement apparatus of claim 3, wherein each one of the plurality of projection members comprises a finger portion extending from 4 mm to 30 mm from a surface of the cleaning apparatus.

8. The impingement apparatus of claim 3, wherein the cleaning apparatus comprises a rotatable drum from which the plurality of projection members extend.

9. The impingement apparatus of claim 3, wherein the plurality of projection members comprise a material selected from the group consisting of stainless steel, low temperature resistant plastic, and low temperature resistant polymer.

10. The impingement apparatus of claim 1, wherein the flexible belt comprises a material selected from the group consisting of stainless steel, low temperature resistant plastic, and low temperature resistant polymer.

11. The impingement apparatus of claim 1, wherein the flexible belt comprises a plurality of sectional members flexibly connected together.

12. An impingement freezer, comprising:
a housing having a chamber therein, and an inlet and an outlet in communication with the chamber;
a conveyer belt disposed for transferring product from the inlet through the chamber to the outlet; and
a flexible belt in communication with the chamber and having a first surface, a second surface opposite to the first surface, and a plurality of impingement holes extending through the belt between the first and second surfaces, wherein a passageway is formed in each one of the plurality of impingement holes and through which a cooling medium can pass for contacting the product on the conveyor belt.

13. The impingement freezer of claim 12, further comprising a cleaning apparatus disposed proximate the flexible belt and having a plurality of projection members extending from the cleaning apparatus, each one of the plurality of projection members sized and shaped to contact a corresponding one of the plurality of the impingement holes to dislodge material and frozen condensate in the passageway of the impingement hole.

14. The impingement freezer of claim 13, wherein the cleaning apparatus is disposed within the chamber and comprises a rotatable drum from which the plurality of projection members extend.

15. The impingement freezer of claim 12, wherein the flexible belt is disposed in the chamber as a continuous loop.

16. The impingement freezer of claim 12, wherein the flexible belt comprises a plurality of sectional members flexibly connected together.
